(19) United States
(12) Patent Application Publication
(10) Pub. No.: US 2026/0269944 A1
(43) Pub. Date: Sep. 10, 2026

(54) Optical Transceiver

(71) Applicant: David George Devers, Lorne (AU)

(72) Inventor: David George Devers, Lorne (AU)

(21) Appl. No.: 19/442,121

(22) Filed: Jan. 7, 2026

(30) Foreign Application Priority Data
Jan. 7, 2025 (AU) 2025900029

(51) Int. Cl. H04B 10/40; H04B 10/50; H04B 10/67

(52) U.S. Cl. CPC H04B 10/40; H04B 10/502; H04B 10/506; H04B 10/67

(57) ABSTRACT

A Optical Transceiver for transmitting and receiving or relaying digital and or analogue signals through optical fibre or laser or wide angel light based signal carrier transmitter. The transmission side incorporating a plurality of light sources such as LED's and a prism and/or a focusing lens and and/or mirror to transmit digital or analogue signals through optical fibre or laser. The plurality of light sources consist of general non-coloured light sources or multi coloured light sources, each light source having different wave lengths of light or archiving different wave lengths of light through a prism or diffraction grating. For example red, orange, yellow, green, blue, violet, ultraviolet and infrared. The receiving side incorporates a focusing lens and or mirror, a prism or diffraction grating or a plurality of light filters and a plurality of photosensitive devices such as photo diodes or photo transistors. Or a plurality photosensitive devices with narrow band wavelength sensitivity. This configuration allows the simultaneous transmission of multiple channels of data increasing the speed of data transfer. Each channel of data is transmitted through a respective coloured light sauce or general non-coloured or coloured light sources and prism, then focused to a single stream of light, at the receiving end this stream of light is split and focused into separate colour wave length streams and received through respective optical sensors or focused to and received with respective narrow band optical sensors. More channels can be added by incorporating polarizing filters and more light saucers in the transmitting side and polarizing filters and more optical photo sensors in the receiving side. Thus creating polarized streams of light with polarized angles. Light sauces are directed through polarizing filters on the transmitting side. On the receiving side the light is directed through more polarizing filters and on to photo sensors. Each channel has a polarized angle and a colour or wavelength of light. Full duplex transmission and reception can be achieved by incorporating both light saucers and light sensors at both ends of the optical fibre or light-carrying medium.

### BACKGROUND

Optical transceivers are available in a number of formes most commonly known is the optical fibre system where digital information is transmitted through glass fibres with the means of a light source at the transmitting end of the fibre and a optical sensor at the receiving end of the fibre.

Another type of optical transceiver is the laser communication system where a light sauce consists of a laser at the transmitting side, this laser is aimed at a optical photo sensor at the receiving side. Information is transferred through this means.

Another form of optical transceiver is a wide angle light based signal carrier. This type of system consists of a light sauce where the emitted light is spread out over a wide angle. A receiving optical photo sensor can be placed anywhere within the aria covered by the angle of the transmitter. Typically this system is utilised for IR headphones and IR remotes.

### DESCRIPTION

This innovation relates to advances in optical communication methods and increases bandwidth and speed of communication by adding more channels that can be transmitted through a transfer medium such as optical fibre and/or a vacuum, air, water or any material that light can pass through. The innovation achieves this by utilising the frequently properties of light to carry channels of communication for given frequencies of light. A more advanced method utilises the polarizing property of light along with the frequency properties of light to increase the number of channels by adding channels for given angles of polarization of light.

The invention incorporates a transmitting unit and receiving unit. The transmitting unit outputs a stream of light, this stream of light can be focused into and transferred through an optical fibre. In another form of invention the transmitting unit can be focused to output a wide angle of light that can be transmitted through a vacuum, air, water or any substance that light can pass through. In another form of invention the transmitting unit can be focused to output as a laser beam by utilising laser light sources, this laser beam can be transmitted through a vacuum, air, water or any substance that light can pass through.

The invention incorporates a receiving unit that inputs a stream of light from an optical fibre. In another form of the invention the receiving unit inputs a stream of light that is transmitted through a vacuum, air, water or any substance that light can pass through.

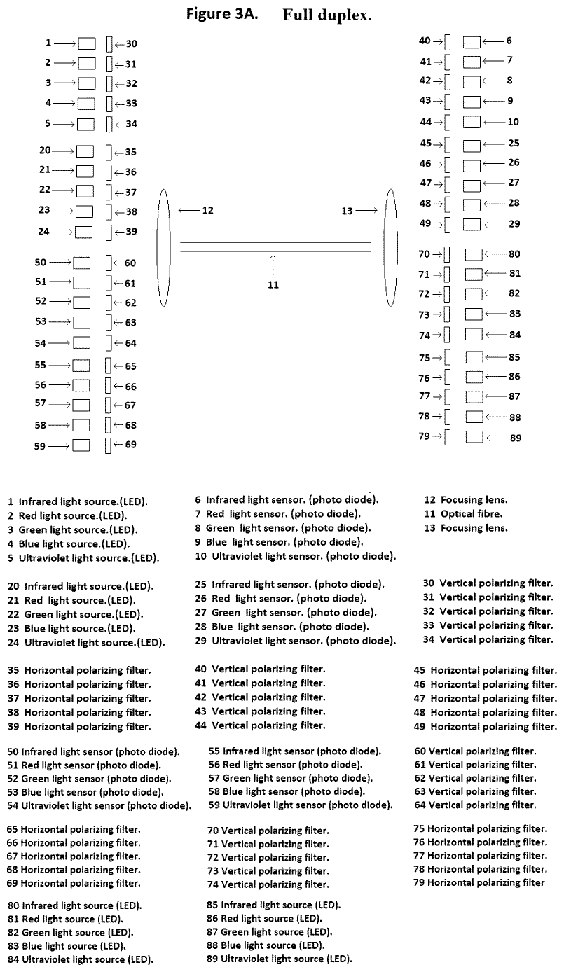

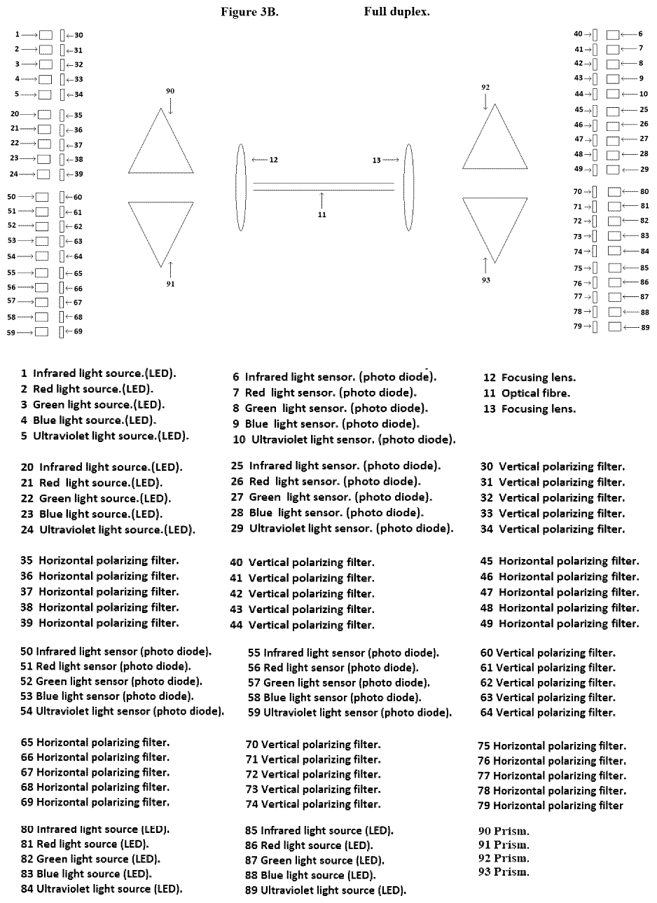

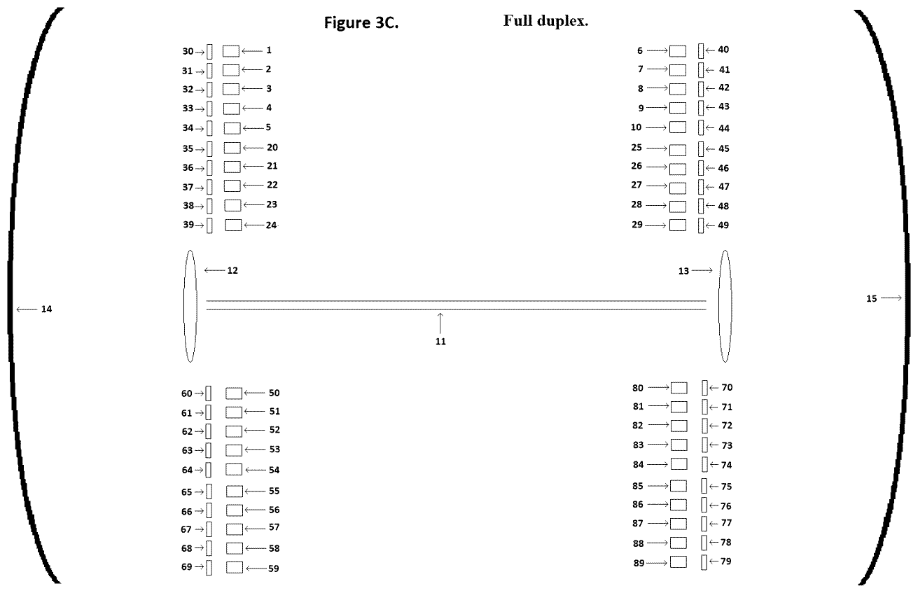

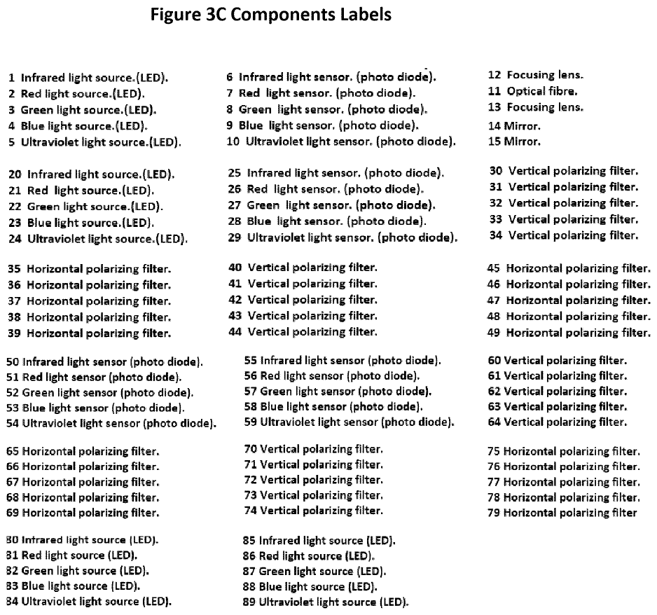

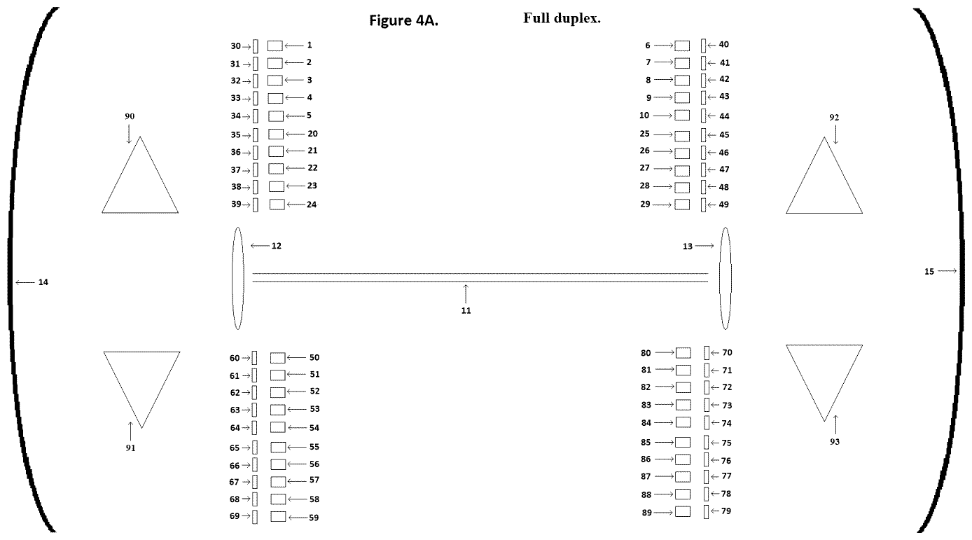

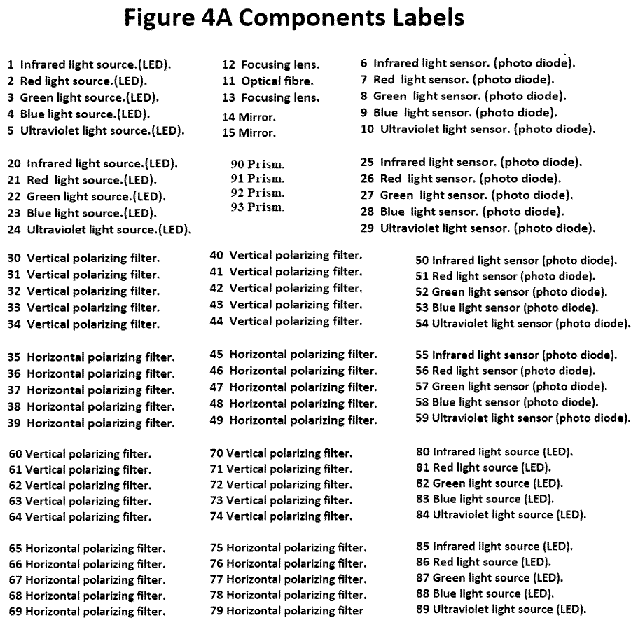

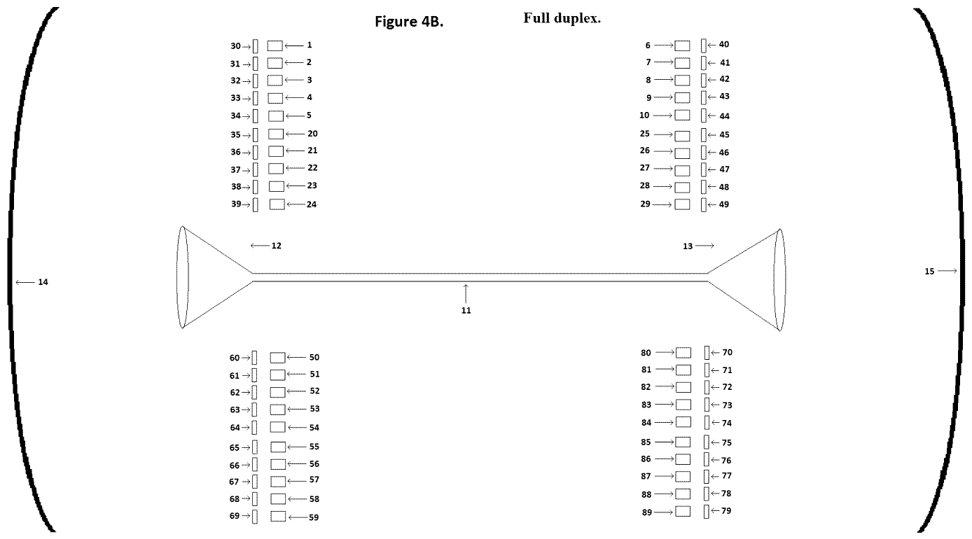

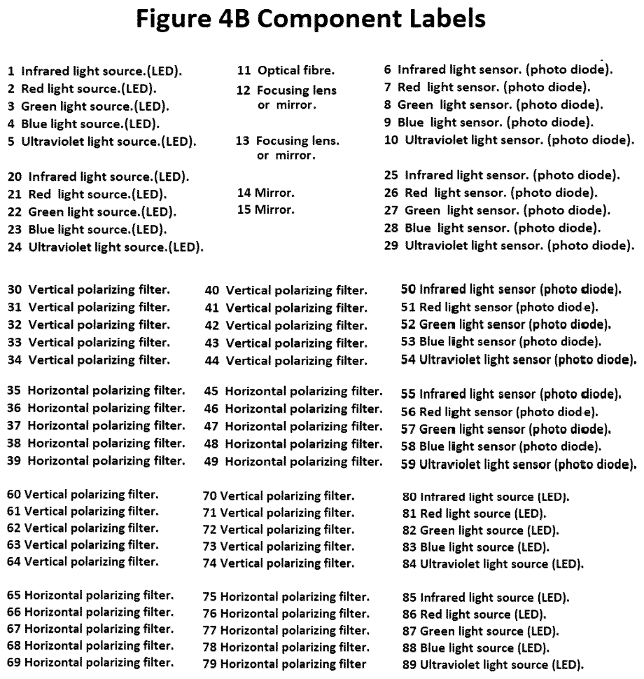

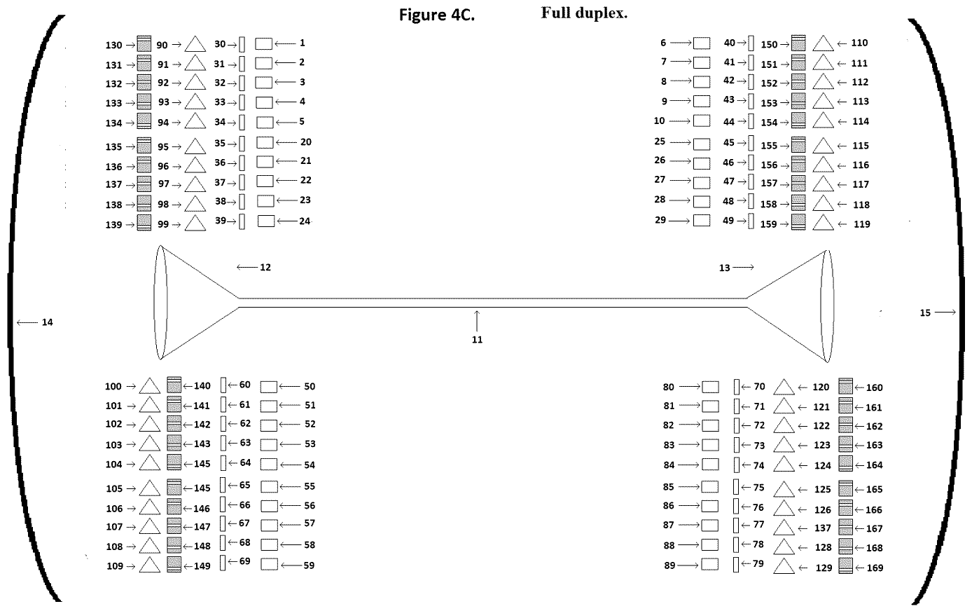

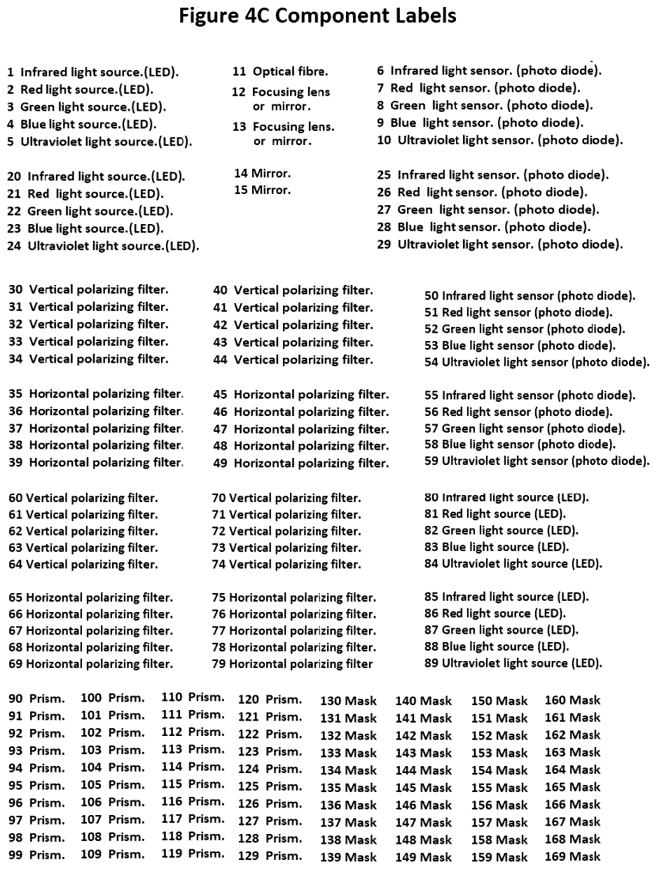

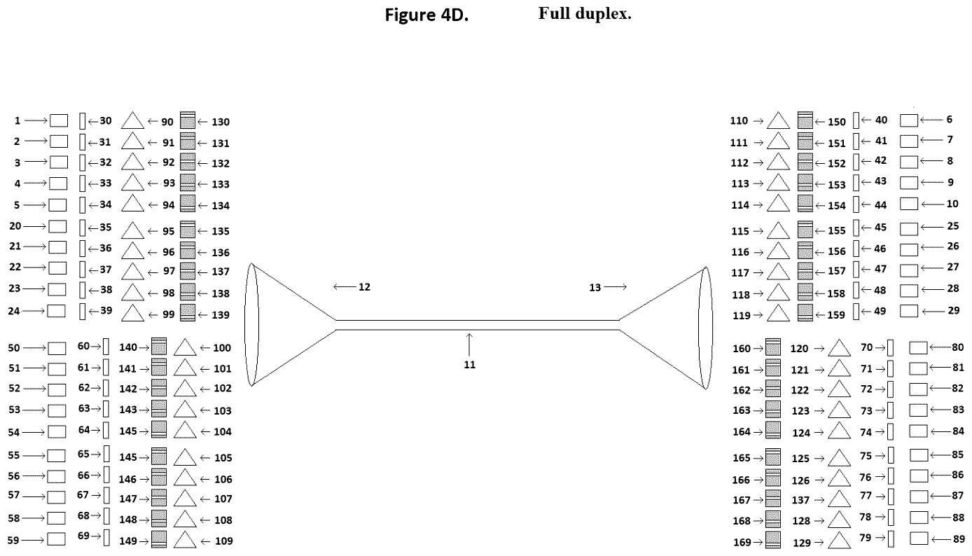

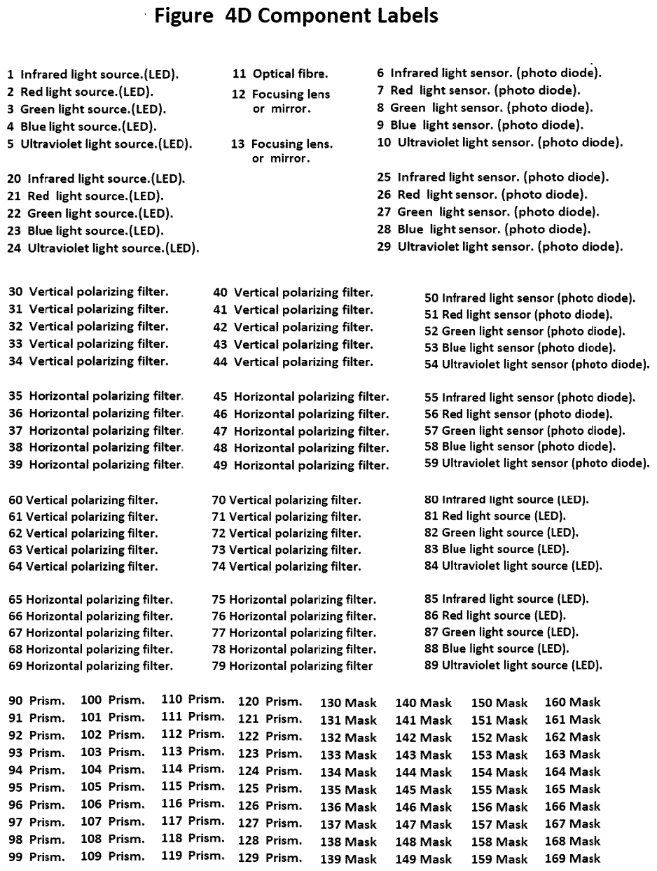

A transmitting unit and a receiving unit can be placed at both ends of an optical fibre for full duplex two-way communication on a single fibre. Likewise for the laser beam and wide-angle versions of the invention. See FIGS. 3A, 3B, 3C, 4A, 4B, 4C & 4D.

### Transmitting Unit

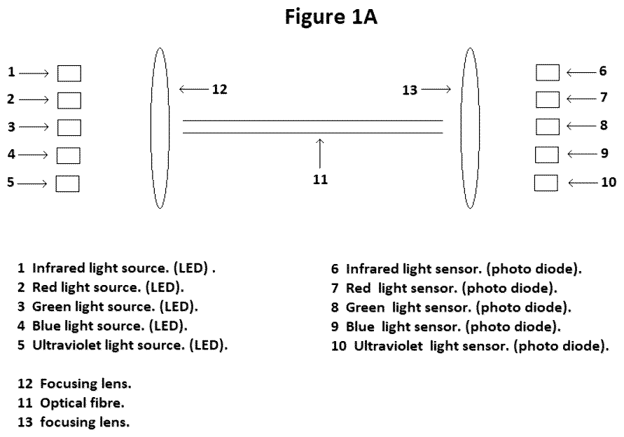

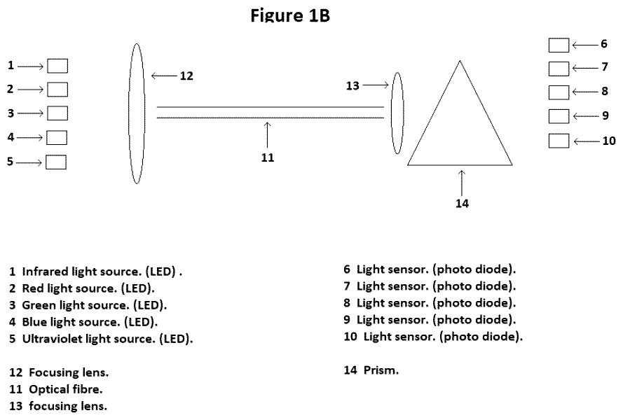

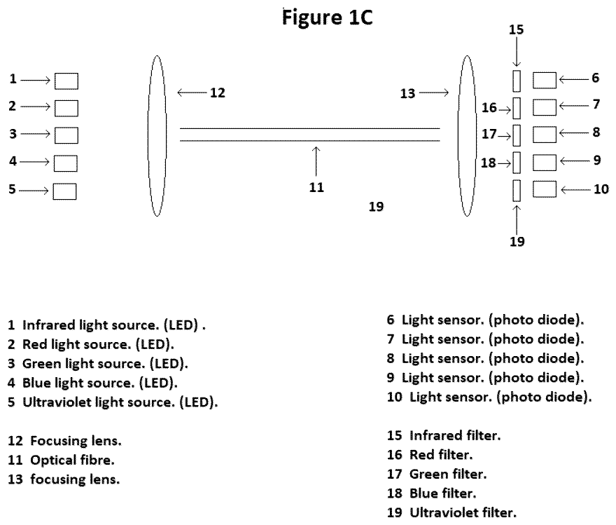

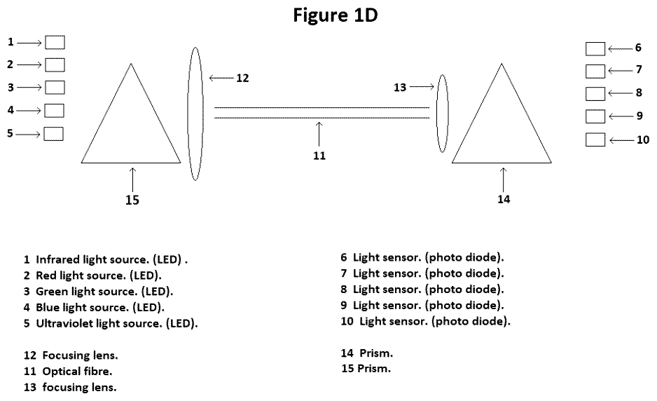

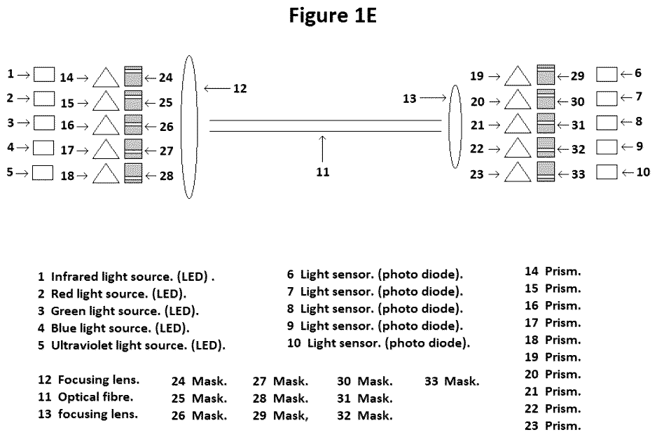

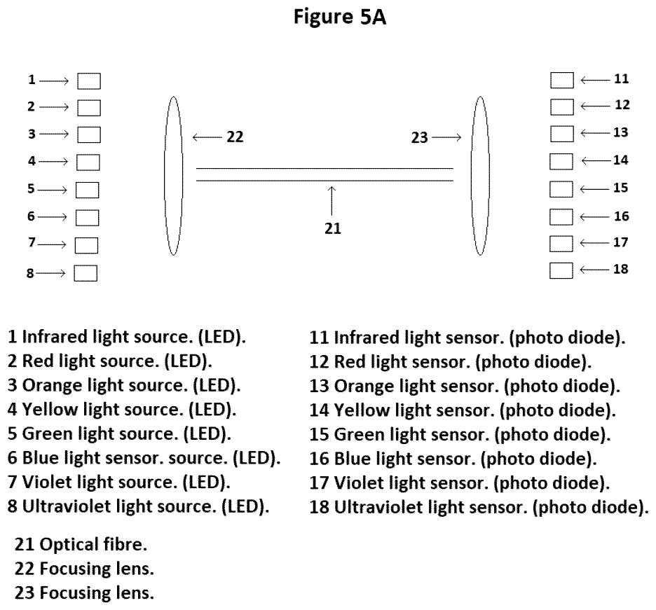

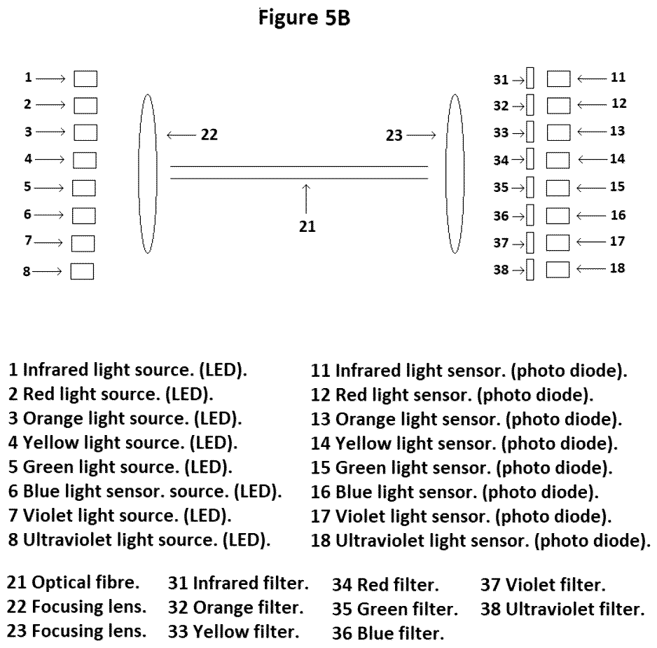

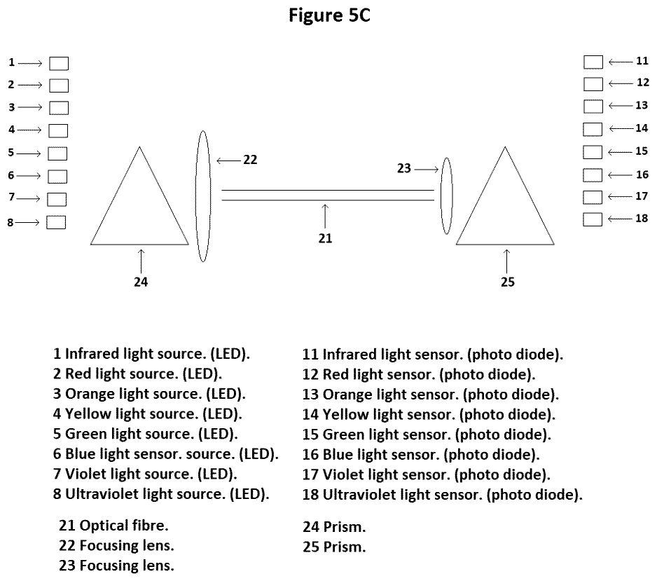

The transmitting unit of the innovation consists of a plurality of light sources that each emit light of different frequency or colour, for example red, orange, yellow, green, blue, violet, ultraviolet and infrared. Other frequencies or colours are deemed to be within the scope of this invention, these light sources can be any device or devices that can emit light. However light emitting diodes LED's are the most practical devices and can be arranged in a number of ways to achieve a light stream. The LED's can be incorporated on a single silicon chip so as to enable them to be arranged close together so they can be focused to a single light stream with less complexity. The LED's can also be arranged so they are spaced apart to dissipate heat and the emitted light is focused to single light stream with a lens and or mirror and or prism. The use of a prism in the transmitter allows the focusing of more narrow frequency bands of light. The position where the prism is placed in respect the light sources and the lens determines the colour and frequency of each channel of light emitted from the prism and focused through the lens. This allows a grater number of channels. For the laser version of the invention the light sources are laser LED's and can be other types of laser light sources. See FIGS. 1A, 1B, 1C, 1D, 1E, 5A, 5B, 5C & 5D.

### Receiving Unit

The receiving unit of the innovation consists of a plurality of light sensors that each detect light of different frequency or colour, for example red, orange, yellow, green, blue, violet, ultraviolet and infrared. Other frequencies or colours are deemed to be within the scope of this invention, these light sensors can be any device or devices that can detect light. However photodiodes and or phototransistors are the most practical devices and can be arranged in a number of ways to achieve light frequency sensing. The light sensors can be incorporated on a single silicon chip or can be arranged so they are spaced apart individually. If the light sensors are frequency bandwidth or light colour sensitive and only respond to respective frequencies or colours, there is no need to incorporate a prism or filters to split the light beam into respective frequencies or colours to detect separate channels. However if the light sensors are wide band light sensitive and respond to a number of light frequencies or colours then a prism or colour filters will be necessary to spit the light beam into respective frequencies or colours to detect respective communication channels. However a prism can also be utilized to focus and direct light to respective light sensors. See FIGS. 1A, 1B, 1C, 1D, 1E, 5A, 5B, 5C & 5D.

In a more advanced form of the invention more channels are added by incorporating polarizing filters and more light sources in the transmitting unit and polarizing filter and more light sensors in the receiving unit.

### Advanced Transmitting Unit

The transmitting unit incorporates a plurality of light sources with a plurality vertical polarising light filters arranged so as the light emitted from each light source passes through a vertical polarising light filter, each light source is of a different colour thus creating streams of vertically polarised light of different colours. The transmitting unit also incorporates another plurality of light sources with a plurality horizontal polarising light filters arranged so as the light emitted from each light source passes through a horizontal polarising light filter, again each light source is of a different colour and thus creates streams of horizontally polarised light of different colours. These light streams are focused into a single stream of light. See FIGS. 3A, 3B, 3C, 4A, 4B, 4C & 4D.

A plurality of light sources may also be arranged so as to pass their emitted light through a single vertical filter. Along with another plurality of light sources arranged so as to pass their emitted light through a single horizontal filter. These light streams are focused into a single stream of light. Light sauces that emit polarised light without the need for filter is deemed to be within the scope of this innovation as well.

A typical configuration would produce a stream of red vertically polarised light, a stream off orange vertically polarised light, a stream off yellow vertically polarised light, a stream off green vertically polarised light, a stream blue vertically polarised light, a stream off a violet vertically polarised light, a stream of infrared vertically polarised light and a stream of ultraviolet vertically polarised light. Along with a stream of red horizontally polarised light, a stream off orange horizontally polarised light, a stream off yellow horizontally polarised light, a stream off green horizontally polarised light, a stream blue horizontally polarised light, a stream off violet horizontally polarised light, a stream of infrared horizontally polarised light and a stream of ultraviolet horizontally polarised light. Other colours or frequencies of light and other angles of polarisation of light are dreamed to be within the scope of this innovation.

### Advanced Receiving Unit

The receiving unit incorporates a plurality of light sensors with a plurality vertical polarising light filters arranged so as the incoming light passes through the polarising light filters. The receiving unit also incorporates a plurality of light sensors with a plurality horizontal polarising light filters arranged so as the incoming light passes through the polarising light filters. Each light sensor reacts to and senses a different colour and polarisation of light thus respective channels of communication are detected for each colour and polarisation of light. In another configuration of the receiving unit, the receiving unit includes just one vertical polarising filter arranged to pass light to a plurality of light sensor and just one horizontal polarising filter arranged to past light to a plurality of light sensors. This configuration is deemed to within the scope of innovation as well.

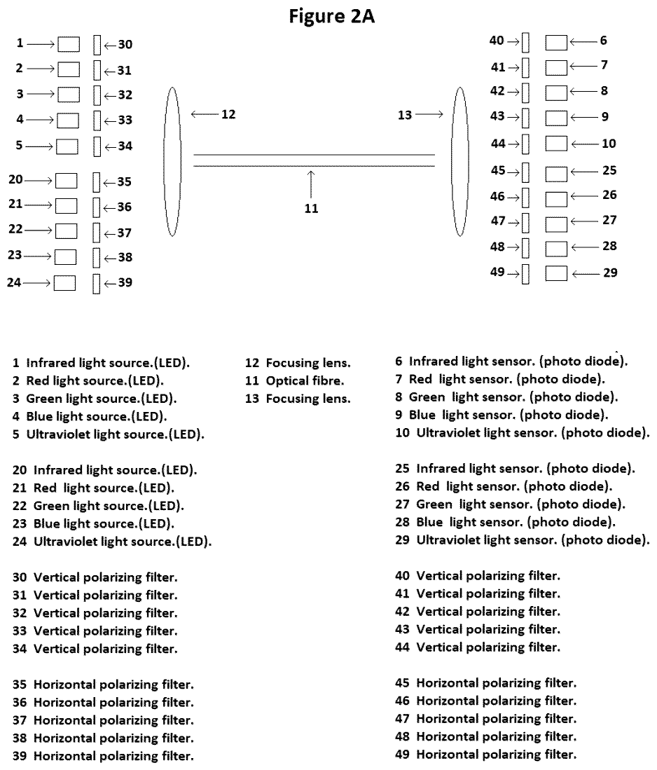

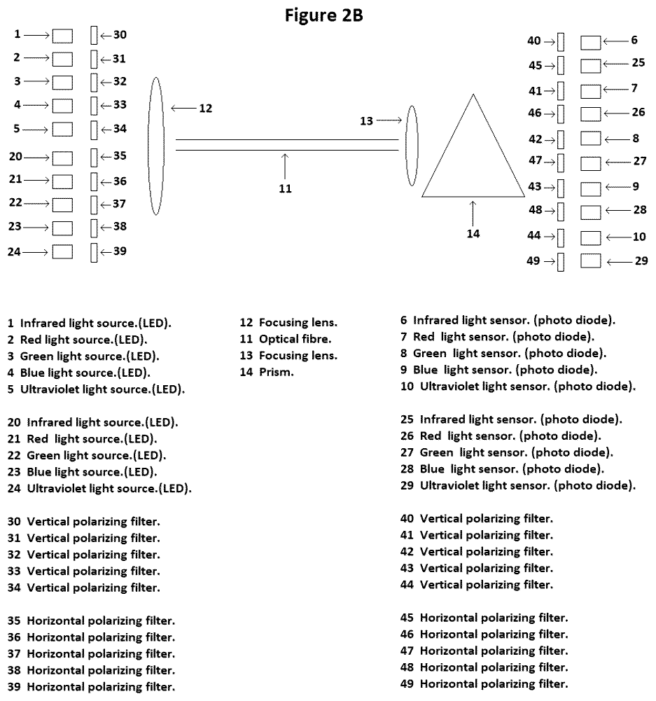

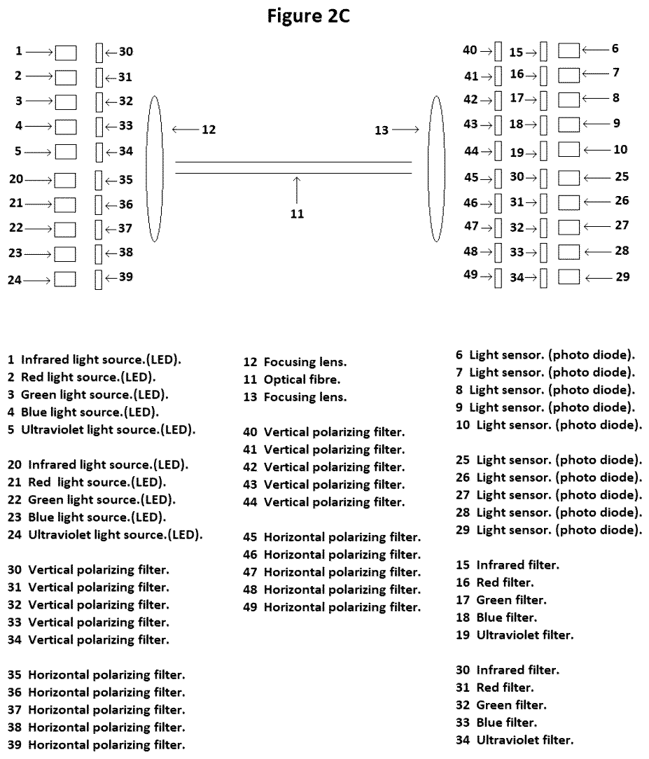

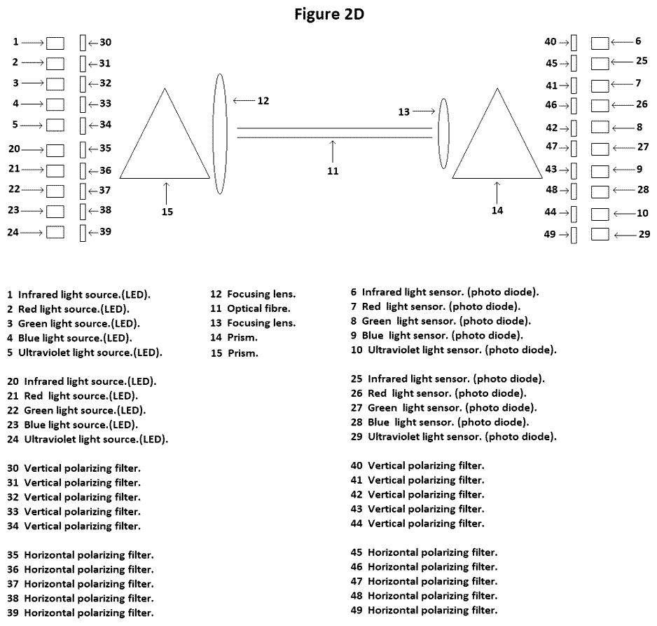

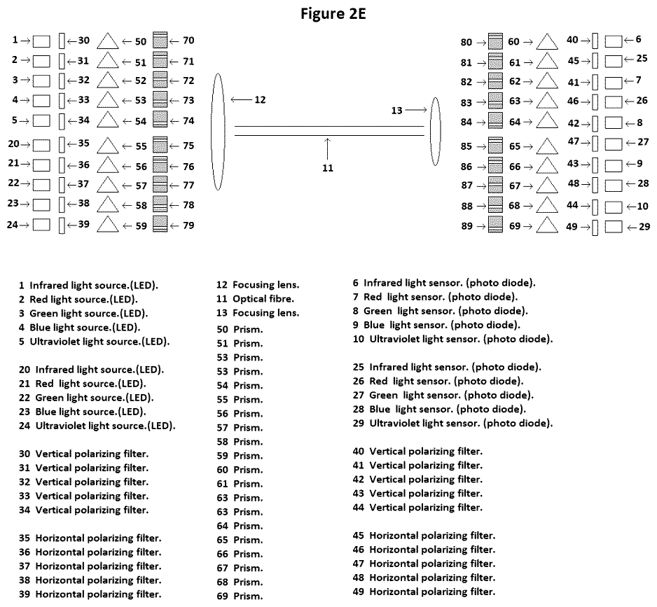

As in the above the receiving unit, if light sensors are narrowband light frequency or colour sensitive, there is no need to incorporate coloured light filters or a prism to separate light beam into different light colours. However if light sensors are wide band sensitive and sensitive to all light colours then coloured light filters or a prism is necessary to separate the light into their respective light colour frequency channels. See FIG. 2A.

One typical configuration of the advanced receiving unit would include a vertical polarising filter arranged for light to pass through onto a red light sensor, a vertical polarising filter arranged for light to pass through onto a orange, a vertical polarising filter arranged for light to pass through onto a yellow light sensor, a vertical polarising filter arranged for light to pass through onto a green light sensor, vertical polarising filter arranged for light to pass through onto a blue light sensor, a vertical polarising filter arranged for light to pass through onto a violet light sensor, a vertical polarising filter arranged for light to pass through onto a vertical polarising filter arranged for light to pass through onto a infrared light sensor, vertical polarising filter arranged for light to pass through onto a ultraviolet light sensor. A horizontal polarising filter arranged for light to pass through onto a red light sensor, a horizontal polarising filter arranged for light to pass through onto a orange light sensor, a horizontal polarising filter arranged for light to pass through onto a yellow light sensor, a horizontal polarising filter arranged for light to pass through onto a green light sensor, horizontal polarising filter arranged for light to pass through onto a blue light sensor, a horizontal polarising filter arranged for light to pass through onto a violet light sensor, a horizontal polarising filter arranged for light to pass through onto a infrared light sensor, horizontal polarising filter arranged for light to pass through onto a ultraviolet light sensor. From this configuration respective channels of communication that are received are as follows, vertical polarised red, vertical polarised orange, vertical polarised yellow, vertical polarised green, vertical polarised blue, vertical polarised violet, vertical polarised infrared, vertical poll arise to ultraviolet, Horizontal polarised red, horizontal polarised orange, horizontal polarised yellow, horizontal polarised green, horizontal polarised blue, horizontal polarised violet, horizontal polarised infrared, horizontal polarised ultraviolet. See FIG. 2A.

Another configurations of the advanced receiving unit would include a vertical polarising filter and a red filter arranged for light to pass through the filters onto a light sensor, a vertical polarising filter and a orange filter arranged for light to pass through the filters onto a light sensor, a vertical polarising filter and a yellow filter arranged for light to pass through the filters onto a light sensor, a vertical polarising filter and a green filter arranged for light to pass through the filters onto a light sensor, a vertical polarising filter and a blue filter arranged for light to pass through the filters onto a light sensor, a vertical polarising filter and a violet filter arranged for light to pass through the filters onto a light sensor, a vertical polarising filter and a infrared filter arranged for light to pass through the filters onto a light sensor, a vertical polarising filter and a ultraviolet filter arranged for light to pass through the filters onto a light sensor. A horizontal polarising filter and a red filter arranged for light to pass through the filters onto a light sensor, a horizontal polarising filter and a orange filter arranged for light to pass through the filters onto a light sensor, a horizontal polarising filter and a yellow filter arranged for light to pass through the filters onto a light sensor, a horizontal polarising filter and a green filter arranged for light to pass through the filters onto a light sensor, a horizontal polarising filter and a blue filter arranged for light to pass through the filters onto a light sensor, a horizontal polarising filter and a violet filter arranged for light to pass through the filters onto a light sensor, a horizontal polarising filter and a infrared filter arranged for light to pass through the filters onto a light sensor, a horizontal polarising filter and a ultraviolet filter arranged for light to pass through the filters onto a light sensor. See FIG. 2C.

Note that a coloured filter and a polarising filter may be included in a single filter that polarises and filters colour simultaneously, for example a red vertical polarising filter, a red horizontal polarising filter, a green vertical polarising filter, a green horizontal polarising filter, a blue vertical polarising filter, a blue horizontal polarising filter, a vertical infrared polarising filter, a horizontal infrared polarising filter, a vertical ultraviolet polarising filter, a horizontal ultraviolet polarising filter, the use of these types of filters is deemed to be within the scope of this invention.

Another configurations of the advanced receiving unit would incorporate a prism that splits the incoming light into separate colours. Vertical polarising filters and horizontal polarizing filters are arranged and placed at points in the separated light streams that are respective to the utilized colours so as each utilized light colour passes through a vertical polarizing light filter onto a light sensor and each utilized light colour passes through a horizontal polarizing light filter onto a light sensor. See FIGS. 2D, 3B, & 4A.

Note that the use of more than one prism is within the scope of this invention. Note that the use of light sensors that are sensitive to polarization of light and colour frequency of light is within the scope of this invention.

Note that the shape of the lenses and/or mirrors incorporated in both the transmitter and receiver are not restricted and can be convex, concaved, cone shaped, funnel shaped or of other shapes that can provide appropriate focusing and is within the scope of this invention. See FIGS. 4B, 4C & 4D.

The use of more than one prism including a separate prism associated with each light source and a separate prism associated with each light sensor allows for finer adjustment of each device and the placement of each device can be more compact and arranged in a more versatile and convenient manner. As there is a prism for each light source the placement of each light source is not dependent on a single prism and the light sources can be placed in much more versatile way, for example in a circle in front of the lens or circles inside a circle in front of the lens or a spiral in front of the lens. The same is true for the light sensors. As there is a prism for each light sensors the placement of each light sensors is not dependent on a single prism and the light sensors can be placed in much more versatile way, for example in a circle behind the lens or circles inside a circle behind the lens or a spiral behind the lens. To allow each prism to filter and focus each required frequency and colour of light more efficiently slotted masks can be placed over each prism to prevent the unwanted frequencies and colours of light from passing through. See FIGS. 1E, 2E, 4C, 4D, & 5D.

For the transmitter each mask has a slot that is placed in a position that along with a respective prism only allows a respective colour and frequency of light to pars from a respective light source. See FIGS. 1E, 2E, 4C, 4D, & 5D.

For the receiver each mask has a slot that is placed in a position that along with a respective prism only allows a respective colour and frequency of light to pars to a respective light sensor. See FIGS. 1E, 2E, 4C, 4D, & 5D.

In another form of optical transceiver the different colours and frequencies of light are derived from utilizing diffraction gratings. These gratings consist of a substrate with a high number of etched parallel angled grooves coated with a highly reflective material. These gratings may consist of strait ruled gratings or concave holographic gratings. Mirrors and/or lenses may be used to focus respective light frequencies. See FIGS. 5A & 5B.

The transmitter unit consists of a number of light sources that are respective to a number of data channels and light frequency colour. Light emitted from each light sources is passed through a slotted mask and is focused on to a diffraction grating, the angels at witch the light intercepts the diffraction grating determines the respective light frequency colour that is reflected from the diffraction grating to a focal point. Each light sources is positioned so as a respective light frequency colour is reflected and focused to the focal point. At this focal point a slotted mask is situated, this mask rejects unwanted frequencies of light. The light that passes through this mask is focused to an optical fibre or laser output. See FIGS. 5A & 5B.

In the receiver unit light emitted from an optical fibre or laser is focused through a slotted mask on to a diffraction grating. This diffraction grating is placed on an angle so as to split the light into respective light frequencies and colours, each respective light frequency is reflected off of the diffraction grating on a different angle. A number of light sensors are positioned to collect respective light frequencies that are respective to data channels. See FIGS. 5A & 5B.

Note that a single diffraction grating or single prism can be utilized to be sheared between a number of optical fibres and number of sets of light sources and/or a number of optical sensors in both the receiving unit and transmitting unit and is deemed to be within the scope of this invention.

Note that utilizing other methods of splitting and/or filtering light into multiple frequencies incorporated in the transmitter unit is within the scope of this invention.

Note that utilizing other methods of splitting and/or filtering light into multiple frequencies incorporated in the receiving unit is within the scope of this invention.

Note that utilizing laser light sources for transmitting light through optical fibres is within the scope of this invention.

Note that combinations of transmitters and receivers with or without prisms or With or without diffraction gratings and based on any of the above configurations and designs are possible and is deemed to be within the scope of this invention.

Note that optical transceivers utilizing other methods of splitting light into a range of colour frequencies such as interference or any other method of splitting light into colour frequencies are within the scope of this invention.

Note that the number of mirrors and lenses comprised in any or all of the above configurations of optical transceivers is not final and that incorporation of greater numbers of mirrors and/or lenses in any or all of the above configurations is within the scope of this invention.

Note that incorporation of slitted or slotted masks in any or all of the above configurations is not final and that any or all of the above configurations may or may not include slitted or slotted masks.

Note that the colours and/or frequencies of light demonstrated are exemplary and that many more colours and/or frequencies of light can be utilized with these innovations, providing many more channels of data and is deemed to be within the scope of this invention.

### DESCRIPTION OF THE DRAWINGS

Note drawings are not to scale and do not depict the exact positioning of the components, nor the comparative sizes of the components. The drawings do not depict angles of placement of the components.

Page 1 of the drawings, FIG. 1A; Optical Transceiver comprising coloured light sauces, focusing lenses and colour sensitive light sensors.

Page 2 of the drawings, FIG. 1B; Optical Transceiver comprising coloured light sauces, focusing lenses, a colour splitting prism and light sensors.

Page 3 of the drawings, FIG. 1C; Optical Transceiver comprising coloured light sauces, focusing lenses, coloured light filters and light sensors.

Page 4 of the drawings, FIG. 1D; Optical Transceiver comprising light sauces, prisms, focusing lenses and light sensors.

Page 5 of the drawings, FIG. 1E; Optical Transceiver comprising light sauces, a plurality of prisms, a plurality of slotted masks, focusing lenses and light sensors.

Page 6 of the drawings, FIG. 2A; Optical Transceiver comprising coloured light sauces, focusing lenses, polarizing light filters and colour sensitive light sensors.

Page 7 of the drawings, FIG. 2B; Optical Transceiver comprising coloured light sauces, polarizing light filters, focusing lenses, a colour splitting prism and light sensors.

Page 8 of the drawings, FIG. 2C; Optical Transceiver comprising coloured light sauces, focusing lenses, polarizing light filters, coloured light filters and light sensors.

Page 9 of the drawings, FIG. 2D; Optical Transceiver comprising light sauces, prisms, focusing lenses, polarizing light filters and light sensors.

Page 10 of the drawings, FIG. 2E; Optical Transceiver comprising light sauces, a plurality of prisms, a plurality of slotted masks, focusing lenses, polarizing light filters and light sensors.

Page 11 of the drawings, FIG. 3A; Full duplex Optical Transceiver comprising coloured light sauces, polarizing light filters, coloured light sensors and focusing lenses.

Page 12 of the drawings, FIG. 3B; Full duplex Optical Transceiver comprising coloured light sauces, polarizing light filters, coloured light sensors, focusing lenses and focusing prisms.

Page 13 of the drawings, FIG. 3C; Full duplex Optical Transceiver comprising coloured light sauces, polarizing light filters, coloured light sensors, focusing lenses and focusing mirrors.

Page 14 of the drawings; FIG. 3C Component Labels.

Page 15 of the drawings, FIG. 4A; Full duplex Optical Transceiver comprising coloured light sauces, polarizing light filters, coloured light sensors, focusing lenses, focusing prisms and focusing mirrors.

Page 16 of the drawings; FIG. 4A Component Labels.

Page 17 of the drawings, FIG. 4B; Full duplex Optical Transceiver comprising coloured light sauces, polarizing light filters, coloured light sensors, cone type focusing lenses or funnel type focusing mirrors and focusing mirrors.

Page 18 of the drawings; FIG. 4B Component Labels.

Page 19 of the drawings, FIG. 4C; Full duplex Optical Transceiver comprising light sauces, polarizing light filters, light sensors, cone type focusing lenses or funnel type focusing mirrors, focusing mirrors, a plurality of prisms and a plurality of slotted masks.

Page 20 of the drawings; FIG. 4C component labels.

Page 21 of the drawings, FIG. 4D; Full duplex Optical Transceiver comprising light sauces, polarizing light filters, light sensors, cone type focusing lenses or funnel type focusing mirrors, a plurality of prisms and a plurality of slotted masks.

Page 22 of the drawings; FIG. 4D Component Labels.

Page 23 of the drawings, FIG. 5A; Optical Transceiver comprising a plurality of coloured light sauces, focusing lenses and a plurality of colour sensitive light sensors. And demonstrates how more channels can be realised by incorporating more light sauces and more light sensors.

Page 24 of the drawings, FIG. 5B; Optical Transceiver comprising a plurality of coloured light sauces, focusing lenses, a plurality of coloured light filters and a plurality of light sensors. And demonstrates how more channels can be realised by incorporating more light sauces and more light sensors.

Page 25 of the drawings, FIG. 5C; Optical Transceiver comprising a plurality of light sauces, prisms, focusing lenses and a plurality of light sensors. And demonstrates how more channels can be realised by incorporating more light sauces and more light sensors.

Page 26 of the drawings, FIG. 5D; Optical Transceiver comprising a plurality of light sauces, a plurality of prisms, a plurality of slotted masks, focusing lenses and a plurality of light sensors. And demonstrates how more channels can be realised by incorporating more light sauces and more light sensors.

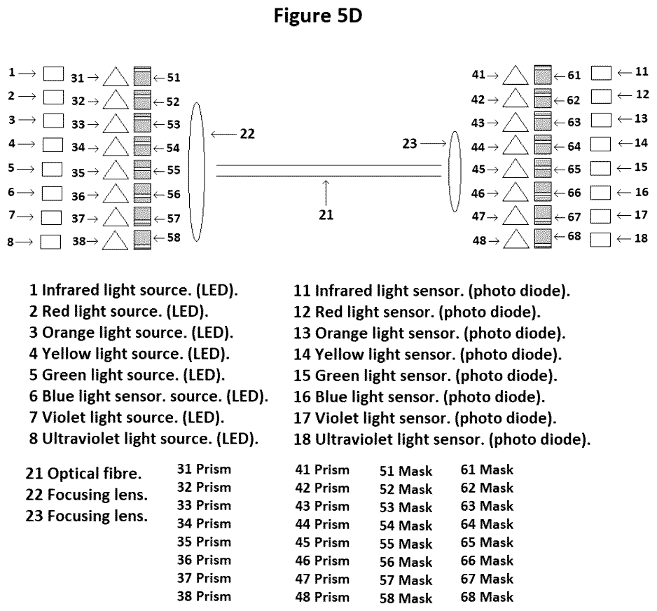

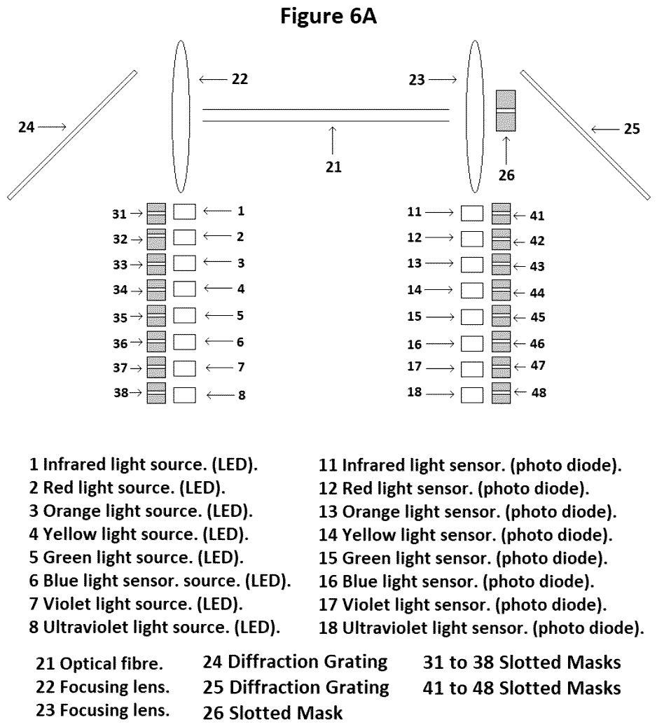

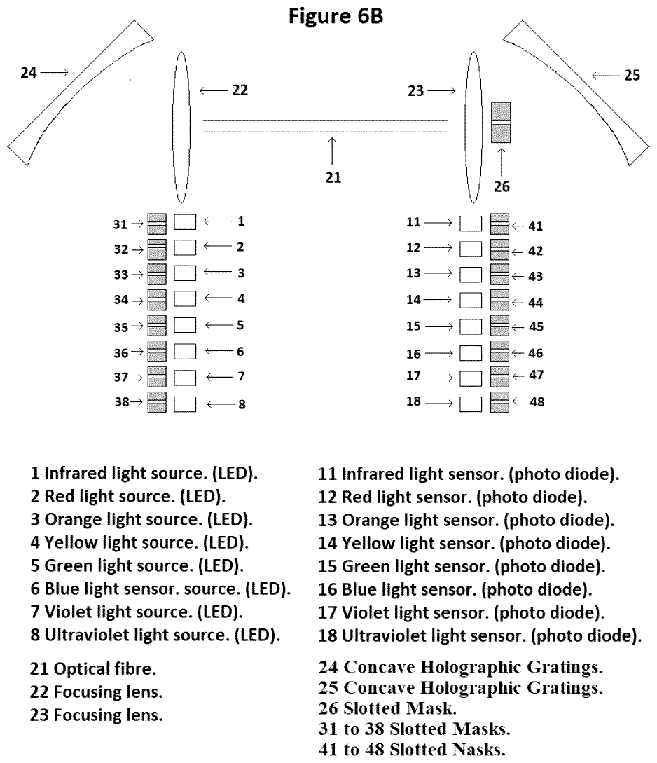

Page 27 of the drawings, FIG. 6A; Optical Transceiver comprising a plurality of light sauces, Diffraction Gratings, a plurality of slotted masks, focusing lenses and a plurality of light sensors.

Page 28 of the drawings, FIG. 6B; Optical Transceiver comprising a plurality of light sauces, Concave Holographic Gratings, a plurality of slotted masks, focusing lenses and a plurality of light sensors.

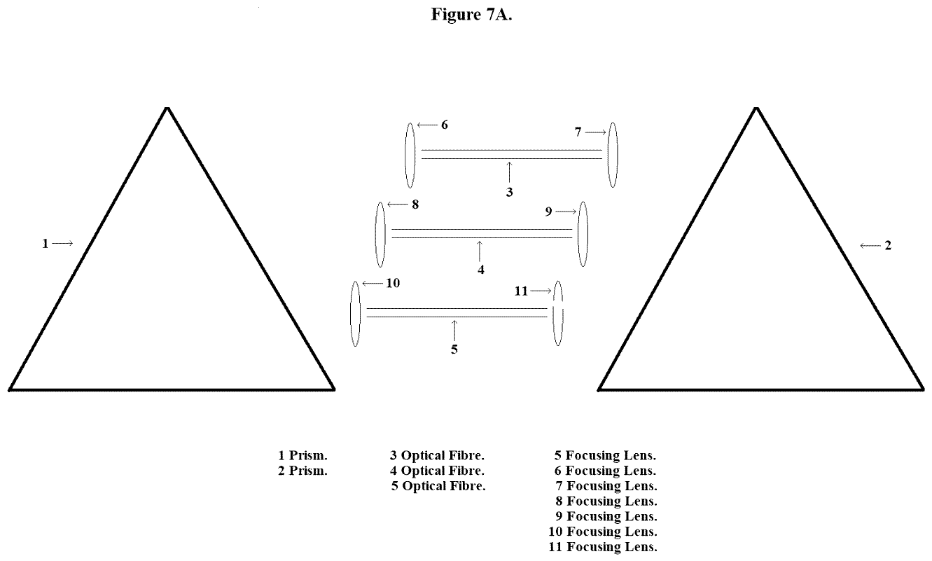

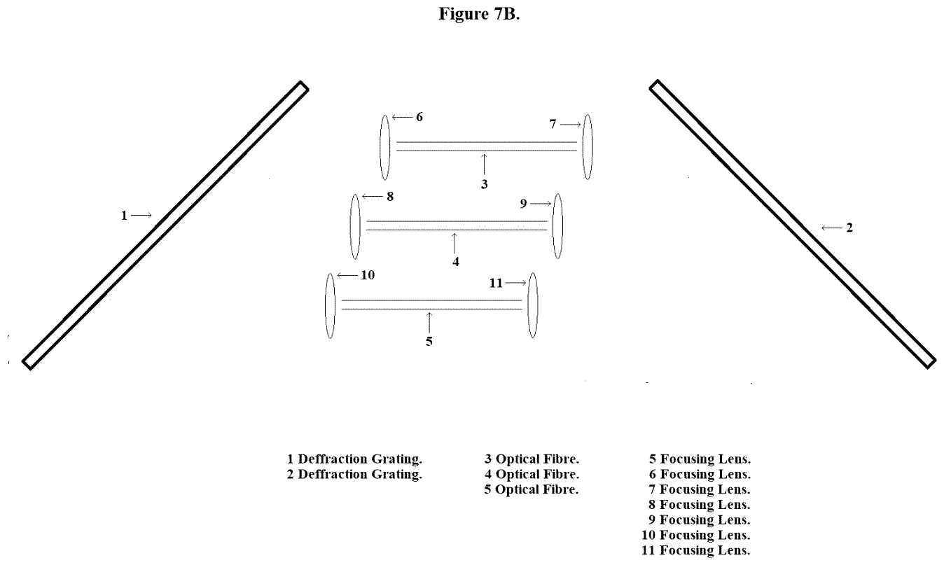

Page 29 of the drawings FIG. 7A Optical Transceiver comprising a transmitter unit where single prism is utilized by a plurality of light output streams and comprising receiver unit where a single prism is utilized by a plurality of light input streams.

Page 30 of the drawings FIG. 7B Optical Transceiver comprising a transmitter unit where single diffraction grating is utilized by a plurality of light output streams and comprising receiver unit where a single diffraction grating is utilized by a plurality of light input streams.

1. A optical transceiver transmitter unit comprising a plurality of light sources that are respectively associated with a plurality of channels, where each light source outputs light of a different colour and frequency to that of the other light sources, where each different colour and frequency of each light source is derived ether from colour and frequency dedicated light source components or through light sources and a means of light frequency and colour filtration.

2. A optical transceiver receiver unit comprising a plurality of light sensors that are respectively associated with a plurality of channels, where each light sensor senses light of a different colour and frequency to that of the other light sensors, where each different colour and frequency sensed by each light sensor is derived ether from frequency and colour sensitive light sensor components or through light sensors and a means of light frequency and colour filtration.

3. A optical transceiver transmitter unit comprising a plurality of light sources that are respectively associated with a plurality of channels, where each light source outputs light of a different colour and frequency and/or polarity to that of the other light sources, where each different colour and frequency of each light source is derived ether from colour and frequency dedicated light source components or through light sources and a means of light frequency and colour filtration, where the light emitted from each light source is polarised ether through filtration or by incorporation of light source components that directly emit polarised light.

4. A optical transceiver receiver unit comprising a plurality of light sensors that are respectively associated with a plurality of channels, where each light sensor senses light of a different colour and frequency and/or polarity to that of the other light sensors, where each different colour and frequency sensed by each light sensor is derived ether from frequency and colour sensitive light sensor components or through light sensors and a means of light frequency and colour filtration and where each light sensor senses the polarity of light ether through polarising filtration or by incorporation of light polarity sensing light sensor components.

5. A optical transceiver transmitter unit of claim 1 and/or claim 3 that incorporates a plurality of light sources, where the light colour and frequency of the light sources is provided by light sources that emit light of the specific colour and frequency that is required to be transmitted for each channel.

6. A optical transceiver receiver unit of claim 2 and/or claim 4 that incorporates a plurality of light sensors, where the light colour and frequency that is sensed by each light sensor is provided by light sensors that are specifically sensitive to the light colours and frequencies that are required to be detected for each channel.

7. A optical transceiver transmitter unit of claim 1 and/or claim 3 that incorporates a plurality of light sources and a plurality of light filters, where each light filter is associated with a light source, where the light colour and frequency of each light source is provided by light sources that emit light that is passed through an associated light filter that filters the specific colour and frequency of light that is required to be transmitted for each channel.

8. A optical transceiver receiver unit of claim 2 and/or claim 4 that incorporates a plurality of light sensors and a plurality of light filters, where each light filter is associated with a light sensor, where the light colour and frequency that is sensed by each light sensor is provided by passing light through an associated light filter that filters the specific light colour and frequency that is required to be detected for each channel.

9. A optical transceiver transmitter unit of claim 1 and/or claim 3 that incorporates a plurality of light sources and a prism, where the light emitted from all the light sources passes through the prism and is split and filtered, where the light sources are placed in a position relative to the prism so that at a focal point on the other side of the prism the light that is emitted from each light source consists of the specific colours and frequencies of light that is required for each channel.

10. A optical transceiver receiver unit of claim 2 and/or claim 4 that incorporates a plurality of light sensors and a prism, where the inputted light stream passes through the prism and is split and filtered into a plurality of light colours and frequencies, where the light sensors are placed in a position relative to the prism so the light received by each light sensor consists of the specific colour and frequency of light that is required by each associated channel.

11. A optical transceiver transmitter unit of claim 1 and/or claim 3 that incorporates a plurality of light sources, a plurality of prisms and a plurality of slotted masks, where there is a prism and slotted mask associated with each light source, where each light source is associated with a respective channel, where the emitted light from each light source is passed through it's associated prism and slotted mask, that splits and filters the light emitted by each light source into the specific colours and frequencies of light that is required for each associated channel.

12. A optical transceiver receiver unit of claim 2 and/or claim 4 that incorporates a plurality of light sensors, a plurality of prisms and a plurality of slotted masks, where there is a prism and slotted mask associated with each light sensor, where each light sensor is associated with a respective channel, where the inputted light is focused to pass through all of the prisms and slotted masks and onto their respective light sensors, where each prism splits and filters the inputted light into the specific colours and frequencies of light that is required for each associated channel.

13. A optical transceiver transmitter unit of claim 1 and/or claim 3 that incorporates a plurality of light sources and a diffraction grating, where the light emitted from each light source is focused on to a diffraction grating, where the diffraction grating splits and filters the emitted light from the light sources into the specific light colours and frequencies required for each of the channels, where each light source is placed in a position so as the light that is reflected from the diffraction grating is focused into a output stream that incorporates the required frequencies and colours of light for all of the channels.

14. A optical transceiver receiver unit of claim 2 and/or claim 4 that incorporates a plurality of light sensors, a slitted mask and a diffraction grating, where the input stream of light is focused to pass through a slitted mask and onto the diffraction grating that splits and filters the light into the colours and frequencies of light that is required for each channel, where light is reflected from the diffraction grating onto light sensors, where each light sensor is placed in a position so as to receive light of the required colour and frequency for it's associated channel,

15. A optical transceiver transmitter unit of claim 1 and/or claim 3 where all of the outputted light colours and frequencies associated with all of the channels are focused into a single output stream of light or where all of the outputted light colours and frequencies associated with all of the channels are focused into a plurality of output streams of light.

16. A optical transceiver receiver unit of claim 2 and/or claim 4 where a single inputted light stream is split and divided into a plurality of light colours and frequencies that are associated with a plurality of channels or where a plurality of inputted light streams is each split and divided into a plurality of light colours and frequencies that are associated with a plurality of channels.

17. A optical transceiver transmitter unit of claim 1 and/or claim 3 where a single diffraction grating or a single prism is utilized by a plurality of light output streams.

18. A optical transceiver receiver unit of claim 2 and/or claim 4 where a single diffraction grating or a single prism is utilized by a plurality of light input streams.

19. A optical transceiver transmitter unit of claim 3 where a plurality of channels consist of a plurality of specific colours and frequencies of light that is horizontally polarised and a plurality of channels consist of a plurality of specific colours and frequencies of light that is vertically polarised.

20. A optical transceiver receiver unit of claim 4 where a plurality of channels consist of a plurality of specific colours and frequencies of light that is horizontally polarised and a plurality of channels consist of a plurality specific colours and frequencies of light that is vertically polarised.
